(19) United States
(12) Patent Application Publication
(10) Pub. No.: US 2005/0138365 A1
(43) Pub. Date: Jun. 23, 2005

(54) Mobile device and method for providing certificate based cryptography

(76) Inventors: Guruprashanth A. Bellipady, Gurnee, IL (US); Douglas T. Michau, Grayslake, IL (US)

Correspondence Address: VEDDER PRICE KAUFMAN & KAMMHOLZ, 222 N. LASALLE STREET, CHICAGO, IL, 60601, US

(21) Appl. No.: 10/741,510

(22) Filed: Dec. 19, 2003

(51) Int. Cl. H04L 9/00

(52) U.S. Cl. 713/158

(57) ABSTRACT

A mobile device and method for providing certificate based cryptography includes a receiver (102) operative to receive a wireless transmission (110). Included within the wireless transmission is a certificate revocation notification (112). The mobile device and method thereof further includes an authenticator (104) operative to receive the certificate revocation notification (112) and operative to authenticate signed comparison data (120) within the certificate revocation notification (112). Upon authentication, an updater (106) is operative to update data representing at least one private or public key (107) based on the certificate revocation notification (112).

### BACKGROUND OF THE INVENTION

The present invention relates generally to secure data communication using certificates from a certification authority and more specifically to updating a certificate revocation status of a certificate in a mobile device.

A pair of related numbers, known as a private key and a public key, parameterizes an encryption algorithm. The public key, known to everyone, allows anyone to encrypt a message for a specific intended recipient; the private key, known only to the intended recipient, allows only that individual to decrypt the message.

Public keys are typically distributed by means of public-key certificates, such as X.509 standard based certificates proposed by the International Telecommunications Union (ITU). A public-key certificate typically consists of a user's distinguished name, the public key to be associated with that name, and the digital signature of a trusted third party, commonly called the certification authority (CA), which binds the name to the key. The certificate may also contain additional fields, including a validity period of the certificate and hence the public key, and a serial number that uniquely distinguishes all certificates from one certification authority. The signature serves as the trusted party's guarantee that the public key is associated with the specified user. When other system users successfully verify that a certificate's signature is correct, using any known verification technique, they may then be reasonably assured that the public key in the certificate is authentic, and may safely proceed to use the public key for appropriate cryptographic applications.

Public key certificates are typically stored in public databases commonly referred to as directories. The validity period in a certificate implies a default expiry date of the certificate, after which time all users should treat the binding between the key and user as invalid. If the certification authority that signed the certificate decides to retract its endorsement of the public key prior to the normal expiry date, the certificate is revoked. Reasons for revoking certificates may include compromise or suspected compromise of the corresponding private key, a time period has lapsed, the user is no longer a member of the CA's domain (failure to pay fees or other reason), early termination of the need for the key or any other suitable purpose.

One method of certificate revocation involves use of a certificate revocation list (CRL). A CRL consists of a list of zero or more pairs of data items, each pair indicating a certificate serial number and the time or date at which the certificate was revoked. The composite list also includes a date of issue or validity period, and is digitally signed by the certification authority to ensure authenticity. Before extracting for use any public key from a certificate, prudent system users verify the signature on the certificate, that the current time precedes the expiry date therein, and that the serial number of the certificate in question does not appear on the most recent valid CRL.

While ideally CRLs are small lists, they may potentially be required to contain as many data items as the number of outstanding certificates in a system. CRLs may grow large under many circumstances, e.g. in environments in which certificates are revoked whenever personnel change jobs or job roles. Large CRLs are a practical concern in systems supporting very large numbers of users. The size of CRLs is a particular concern in systems that require that CRLs be retrieved under the following conditions: from public directories; over low-bandwidth channels; and/or on a frequent basis.

In one implementation, certificates are utilized to provide a level of trust and security for various types of communications. An exemplary usage of certificates is with internet-based transactions, such as e-commerce. Using public keys, sensitive information, such as a credit card information, may be encrypted for transmission. Thereupon, using a private key, the credit card information may be decrypted, wherein a signature within the transmission is verified and the certificate is validated.

Another exemplary embodiment of the usage of certificates is person to person communication. For example, an electronic mail (email) transmission may be signed with a public key so the recipient may verify the signature with a private key and validate a certificate. These messages may further be transmitted to and/or from mobile devices, wherein a mobile device may be a cellular phone, a smart phone, a personal digital assistant, a wireless computer having an RF transceiver or any other suitable wireless communication device. An example of a transmission may be a wireless text message sent to the mobile device, wherein the certificate must be validated in order to be trusted.

In the mobile device, using the CRL can be problematic due to bandwidth restrictions and processing requirements. Problems arise not only in the transmission of the CRL itself, due to its size and the bandwidth limitations for the mobile device, but also in available memory on the mobile device to store the CRL.

One proposed solution is an Online Certificate Status Protocol (OCSP). During a standard communication session, such as a web browsing session, the mobile device may seek to validate a certificate. The protocol requires that when a mobile device seeks to validate a certificate, the mobile device sends an OCSP request to an OCSP server, wherein the OCSP request includes the certificate to be validated. The OCSP request is sent in accordance with a telecommunications protocol internet protocol (TCP/IP) in conjunction with the existing web browsing session. The OCSP server transmits an OCSP request that includes a service request and the certificate to be validated, to a corresponding CRL. Based on the CRL, the OCSP server receives a response that the certificate is current, expired or unknown. The OCSP server then transmits this response in a signed format back to the mobile device. The mobile device verifies the signature of the OCSP response. If the OCSP response is verified, the mobile device reads the response regarding the status of the certificate. This solution is inefficient because the mobile device must: (1) generate the OCSP request; (2) transmit the OCSP request to the OCSP server; (3) receive signed the response back from the OCSP server; and (4) verify the signature of the OCSP response, prior to trusting the determination by the OCSP server as to whether the certificate is valid.

### BRIEF DESCRIPTION OF THE DRAWINGS

The invention will be more readily understood with reference to the following drawings wherein:

FIG. 1 illustrates one example of a mobile device for providing certificate based cryptography;

FIG. 2 illustrates a representation of a certificate revocation notification;

FIG. 3 illustrates another example of a mobile device for providing certificate based cryptography;

FIG. 4 illustrates a certificate based cryptography system;

FIG. 5 illustrates an example of the steps of a method for providing certificate based cryptography;

FIG. 6 illustrates another example of steps of a method for providing certificate based cryptography in a mobile device; and

FIG. 7 illustrates example of the steps of the operation of a system providing certificate based cryptography.

### DETAILED DESCRIPTION OF PREFERRED EMBODIMENTS OF THE INVENTION

Briefly, a mobile device and method for providing certificate based cryptography includes a receiver operative to receive a wireless transmission. The receiver may be a receiver component typically found within a mobile device, either independent of or in conjunction with the transmitter/receiver. The receiver is operative to receive the wireless transmission via an antenna or other receiving means. In the mobile device and method for providing certificate based cryptography, the certificate revocation notification is received over a broadcast channel, wherein a broadcast channel is a specifically defined channel, such as a range of frequencies, for the communication of data thereacross, the broadcast channel may include a messaging system channel, such as a short messaging system (SMS) channel, an extended messaging system (EMS) channel, a multi-modal messaging (MMS) system, a date or communication channel, a designated range of frequencies within a standard broadcast channel, or any other suitable channels for providing the transmission of broadcast information.

The mobile device and method thereof further includes an authenticator operative to receive the certificate revocation notification. In one embodiment, the authenticator operatively receives the certificate revocation notification from the receiver and the authenticator is operative to authenticate signed comparison data included within a certificate revocation notification. The mobile device and method further includes an updater coupled to the authenticator. The updater is operative to update data representing at least one private or public key based on the certificate revocation notification. Thereupon, the mobile device and method allows for certificate based cryptography through updating public or private key information with respect to a received certificate revocation notification that is pushed to the mobile device.

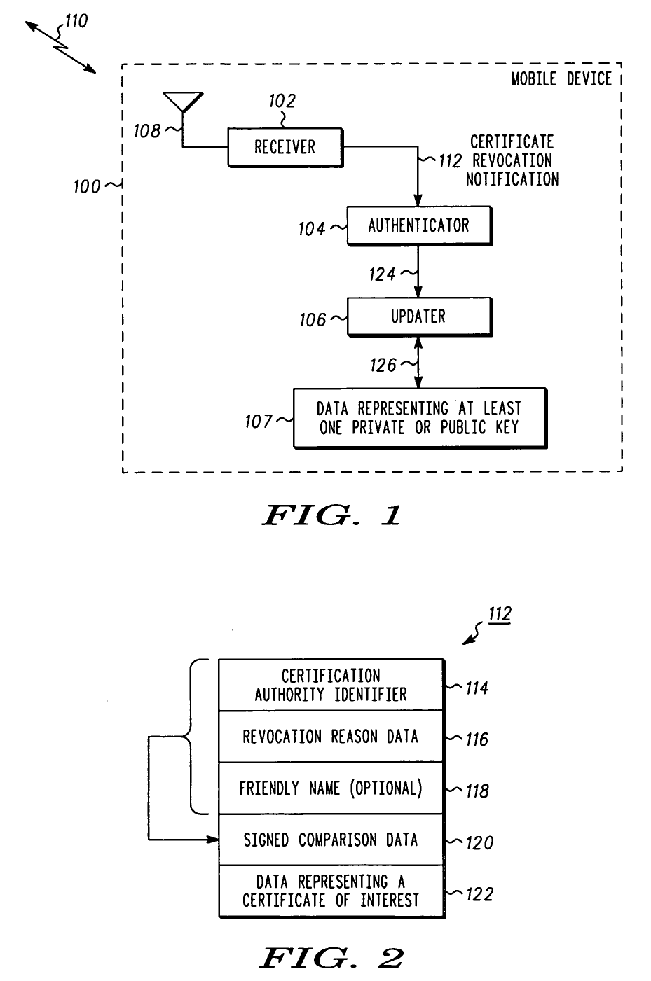

More specifically, FIG. 1 illustrates one embodiment of a mobile device 100 including the receiver 102, an authenticator 104, an updater 106 and data representing at least one private or public key 107. The receiver 102 further includes an antenna 108 which may extend outside of the mobile device 100 and is capable of receiving a wireless transmission 110. The authenticator 104 and updater 106 may represent executable program instructions, individual processors, application specific integrated circuits, digital signal processors, microprocessors, firmware, microcontrollers, state machines, or any other recognized operational component capable of executing program instructions wherein the programming instructions may be disposed on a ROM, RAM, EEPROM, compact disc, digital versatile disc, optical medium, or any other volatile or non-volatile storage medium. Moreover, the data representing at least one private or public key 107 may be disposed in a storage location, such as but not limited to a database.

In this embodiment, the wireless transmission 110 includes a certificate revocation notification, as described in further detail below with regards to FIG. 2. The certificate revocation notification may be included within a general broadcast, combined with other broadcast data, may be the sole content of the wireless transmission 110 or any other suitable broadcasting format as recognized by one having ordinary skill in the art. Regardless thereof, it is understood that the wireless transmission 110 further includes all relevant standard transmission data, including any applicable header information for proper communication and reception by the mobile device 100.

Upon receipt of the wireless transmission 110, the receiver 102 provides the certificate revocation notification 112 to the authenticator 104. In one embodiment, the authenticator 104 authenticates signed comparison data included within the certificate revocation notification. As illustrated in FIG. 2, one embodiment of the certificate revocation notification 112 includes a certification authority identifier 114, revocation reason data 116, an optional friendly name 118, signed comparison data 120 and data representing a certificate of interest 122.

The certification authority identifier 114 is a data representation of a certification authority, such as a multi-byte representation used to identify the certification authority. As recognized by one having ordinary skill in the art, the certification authority identifier 114 may be any suitable data structure which is utilized for the purpose of identifying a corresponding certification authority. The revocation reason data 116 is a string element including data directed to the reason for the revocation of the certificate of interest. The revocation reason data 116 may be any suitable data structure capable of providing a corresponding indication of the reason for the revocation of the certificate, such as but not limited to the data string including text of the revocation reason, a value indicating a preset term for revocation, where in at least one embodiment, one equates to expiration of certificate and two equates to security breached, or any other suitable indicator as recognized by one having ordinary skill in the art.

In at least one embodiment, the certificate revocation notification includes the friendly name 118. As noted in FIG. 2, this element is optional within the certificate revocation notification 112 and the friendly name 118 may be any suitable data structure providing for an indication of a friendly name of the certification authority. For example, the friendly name may be an actual name by which an end-user of the mobile device is familiar, such as the name of a website the user has previously conducted secured transactions. As recognized by one having ordinary skill in the art, the friendly name may be any suitable data structure capable of providing a visual output of recognized name of the certification authority or any certification authority within a domain of trust from the certification authority. The domain of trust may be any certification authority in relation to any other certification authorities wherein certificate validation may be supported through any certification authorities or a root certificate.

Further included within one embodiment of the certificate revocation notification 112 is signed comparison data 120. The signed comparison data 120 is, in one embodiment, the combination of the certification authority identifier 114 and the revocation reason data 116, compressed using a hash algorithm. Any suitable hash algorithm such as but not limited to an SHA1 algorithm may be utilized to generate the signed comparison data 120. Furthermore, the signed comparison data 120 is then signed by the certificate. Therefore, further included with the certificate revocation notification is data representing a certificate of interest 122. The data representing a certificate of interest 122 may be any suitable data providing for the representation of the certificate for whom the certificate revocation notification 112 is generated. In one embodiment, the data representing a certificate of interest 122 may be the actual certificate from the certification authority, may be a specific pointer, such as a universal resource locator, directed to a location to retrieve the actual certificate from the certification authority, or any other suitable data structure as recognized by one having ordinary skill in the art.

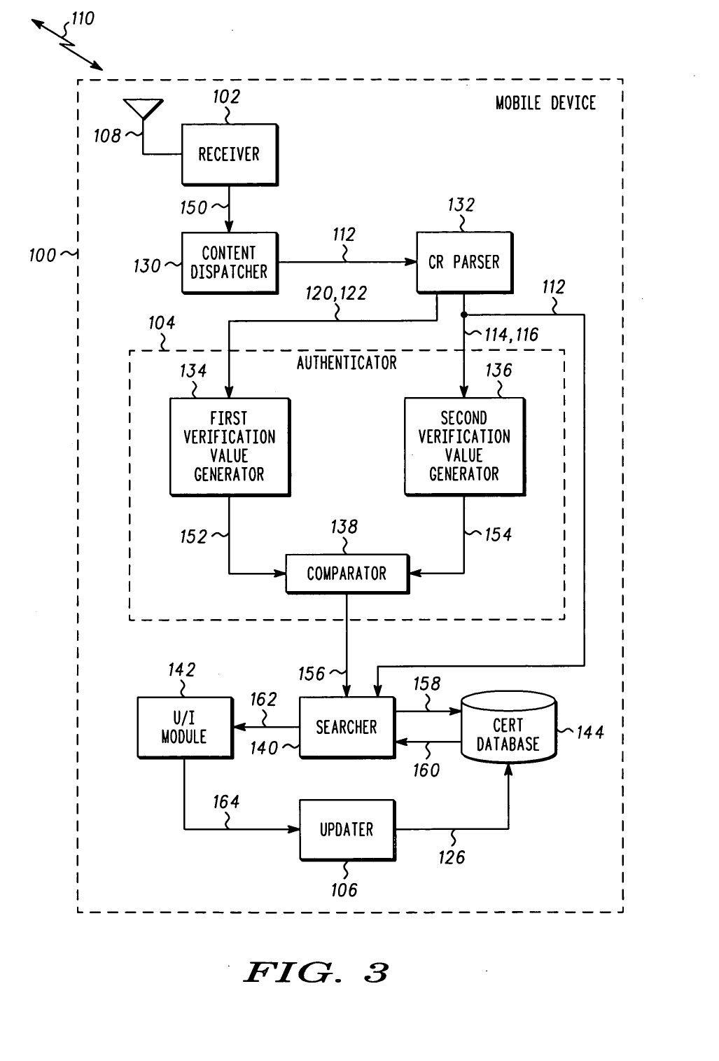

Referring back to FIG. 1, the authenticator 104 authenticates the signed comparison data 120 included within the certificate revocation notification 112, wherein the authentication process performed by one embodiment of the authenticator is described in further detail below with regards to FIG. 3. Upon authentication, the authenticator 104 provides an update command 124 the updater 106, the updater 106 operative to update data representing at least one private or public key based on the certificate revocation notification 124 including in one embodiment sending a disable or delete command 126. FIG. 1 also illustrates the receiver 102 coupled to the authenticator 104 and the authenticator 104 coupled to the updater 106, whereas the coupling of these elements may be directly or indirectly coupled with other elements, not illustrated herein, disposed therebetween, such as illustrated below in FIG. 3.

FIG. 3 illustrates a further embodiment of the mobile device 100 for providing certificate based cryptography. The mobile device 100 includes the receiver 102 having the antenna 108, a content dispatcher 130, a certification revocation (CR) parser 132, a first verification value generator 134, a second verification value generator 136 and a comparator 138. In one embodiment, the first verification value generator 134, the second verification value generator 136 and the comparator 138 are disposed within the authenticator 104. Further included within the mobile device 100 is a searcher 140, a user interface module 142, the updater 106 and a certificate database 144, wherein the certificate database includes data representing at least one private or public key.

The mobile device 100 receives the wireless transmission 110 which includes the certificate revocation notification, 112 of FIG. 2, via the antenna 108 of the receiver 102. Upon receipt, the receiver 102 sends the content 150 of the wireless transmission 110 to the content dispatcher 130. In one embodiment, the content dispatcher 130 removes any header or other overhead information and provides the certificate revocation notification 112 directly to the CR parser 132.

In one embodiment the CR parser 132 parses the information within the certificate revocation notification 112 and provides two sources of information to the authenticator 104. In one embodiment, the CR parser 132 provides the signed comparison data 120 and the data representing the certificate of interest 122 to the first verification value generator 134. The CR parser 132 further provides the certification authority identifier 114 and the revocation reason data 116 to the second verification value generator 136.

In one embodiment, the first verification value generator 134 generates a first verification value 152 which is provided to the comparator 138. In one embodiment, the first verification value 132 is generated through the verification of the signed comparison data 120 using the data representing a certificate of interest 122. In the embodiment where the data representing a certificate of interest is the certificate, the certificate is utilized to decrypt the signed comparison data, therein generating the hashed certification authority identifier 114 and revocation reason data 116. In the embodiment where the data representing a certificate of interest 122 is a pointer, the first verification value generator 134 is operative to retrieve the certificate from the appropriate location and then perform the decryption process.

The second verification value generator 136 generates a second verification value 154 that is provided to the comparator 138. In one embodiment, the second verification value 154 includes the combination of the certification authority identifier 114 and the revocation reason data 116 and the hashing of this combined term using the same hash algorithm utilized to generate the signed comparison data 120 within the certificate revocation notification. Therefore, the comparator 138 compares the first verification value 152 with the second verification 154 and if these values are the same, the comparator can thereby determine that the certificate 122 is proper.

The first verification value generator 134, the second verification value generator 136 and the comparator 138 may represent executable program instructions, individual processors, application specific integrated circuits, digital signal processors, microprocessors, firmware, micro controllers, state machines or any other recognized operational component capable of executing program instructions wherein. the programming instructions may be disposed on a ROM, RAM, EEPROM, compact disc, digital versatile disc, optical medium, or any other volatile or non-volatile storage media.

The comparator 138 within the authenticator 104 thereupon provides an authentication signal 156 to the searcher 140 indicating that the certificate revocation notification 112 has been authenticated. In one embodiment, the CR parser 132 further provides the certificate revocation notification 112 directly to the searcher 140. As recognized by one having ordinary skill in the art, the certificate revocation notification 112 may also be provided directly from the content dispatcher 130.

The certificate database 144, in one embodiment, includes the data representing at least one private or public key 107 of FIG. 1. The searcher 140 sends a search request signal 158 to the certificate database 144 such that the certificate database 144 can retrieve the certificate of interest 160. The searcher 140, upon receiving the certificate 160 determines that the certificate of interest 160 is contained within the certificate database 144, therefore the certificate revocation notification 112 is applicable to the mobile device 100.

In response thereto, the searcher 140 provides a display signal 162 to the user interface(U/I) module 142. In one embodiment, the user interface module 142 provides a notification to an end user of the mobile device 100 that a certificate revocation notification 112 has been received. The U/I module 142 provides an output display of the certification authority identifier 114, the revocation reason data 116 and when included in the certificate revocation notification, the friendly name 118. Therefore, in one embodiment, the U/I module 142 allows the user of the mobile device 100 to either accept or reject the certificate revocation notification including the revocation reason data 116.

Based on user inputs, the U/I module 142 provides an update response 164 to the updater 106. In the event the user has accepted the revocation, the updater 106 then transmits the delete or disable command 126 to the certificate database 144 such that the certificate of interest is thereby noted in the database as no longer being valid.

FIG. 4 illustrates a system utilizing certificate based cryptography. FIG. 4 illustrates a certification authority (CA) vendor 170, which may be any suitable entity which issues or utilizes certificates, such as but not limited to an online website, a secure transmission web server or an online banking system. In the event that a certificate is revoked by the CA vendor 170, the CA vendor 170 issues a certificate revocation 172 to an operator 174. The certificate revocation 174 may be any form of notice stating that particular certification has been revoked. The revocation of the certificate may be relative to any certification authority within the domain of trust.

The operator 174, which may be any suitable wireless operating system, such as a commercially available wireless service provider, receives the certificate revocation 172 and thereupon generates a message to include a certificate revocation notification. In one embodiment, the operator 174 may, seamlessly using standard processing technology, generate the data fields for the certificate revocation notification as illustrated in FIG. 2. For example, the certificate revocation 172 includes the identity of the certification authority, the reason for the revocation, a friendly name if to be included in the notification and data representing a certificate of interest. In accordance with the same operation described for authenticating the certificate revocation notification, the operator 174 generates the signed comparison data 120 through the hashing of the combination of the certification authority identifier 114 and the revocation reason data 116.

In accordance with different embodiments, the operator 174 may seek to transmit the wireless message 110 across either a standard broadcast message 176 or utilizing a messaging system, such as a SMS system with a short messaging system center 178. In the embodiment using the broadcast message 176, the operator 174 generates a standard broadcast message to be transmitted to all mobile devices 100 capable of receiving the broadcast message from the operator 174. In one embodiment, the broadcast message 176 is transmitted to a standard wireless network 180 such that the wireless message 110 is then broadcast in accordance with known broadcast technology. In another embodiment, the wireless message 110 may be broadcast across a dedicated broadcast channel, such as a designated range of frequencies. In utilizing a broadcast message 176, the channel identifiers are utilized to indicate the presence of the certificate revocation notification for transmission upon the dedicated channel.

In an embodiment utilizing the messaging system, a message 182 is generated by the operator, such as a SMS message including standard SMS data the message 182 is provided to the short messaging system center 178 and the message is incorporated with an SMS message 184. In accordance with known messaging technology, the SMS message 184 is provided to the wireless network 180 and broadcast across the messaging channel. In one embodiment, a port ID within the SMS message is set to a specific number to indicate that it contains a certificate revocation notification.

From the wireless network 180, the wireless communication 110 is transmitted to a plurality of mobile devices 100, wherein FIG. 4 illustrates the single mobile device 100. As recognized by one having ordinary skill in the art, multiple mobile devices 100 represent various mobile devices subscribed to the operator 174 and further engaging the CA vendor 170. The system of FIG. 4 utilizes a push technology to seamlessly deliver new information from the CA vendor 170 to mobile devices 100 without requiring modifications from the CA vendor 170 and the operator 174 implementing processing for receiving the certificate revocation 172, converting the certificate revocation into a certification revocation notification and then providing the certificate revocation notification to either an existing broadcast message or to a messaging center for transmission to the mobile devices 110. Moreover, as recognized by one having ordinary skill in the art, when utilizing a broadcast message 176, the wireless message 110 is transmitted to all mobile devices 100 and in the embodiment utilizing the message 182, the SMS message 184 may be provided to specific assigned mobile devices 100 associated with the CA vendor 170.

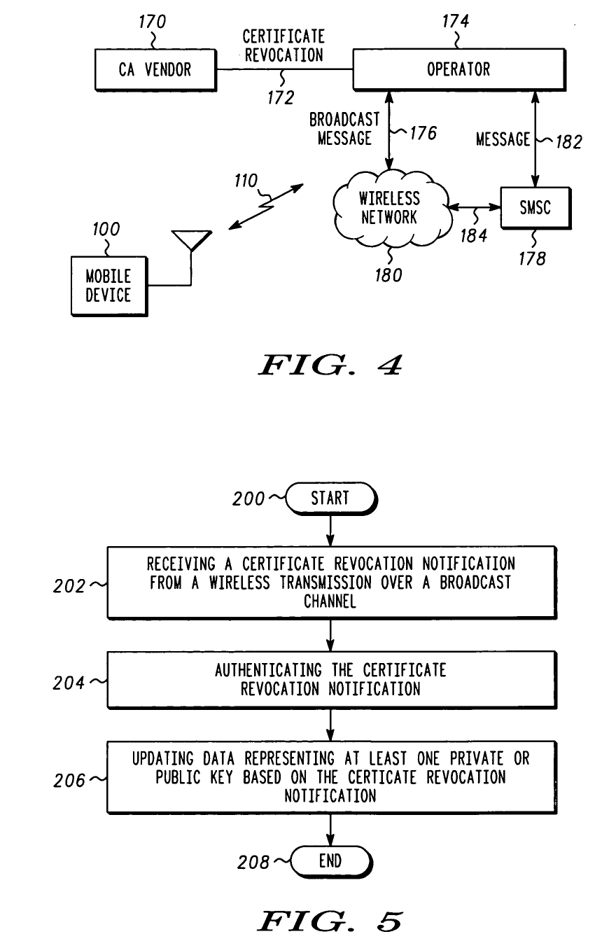

FIG. 5 illustrates the steps of a method for providing certificate based cryptography in a plurality of mobile devices. The method begins, step 200, by receiving a certificate revocation notification from a wireless transmission over a broadcast channel, step 202. As discussed above with regard to FIGS. 1-3, the wireless transmission 110 is received by a receiver 102 within the mobile device 100 wherein the wireless transmission 110 includes the certificate revocation notification 112.

Step 204 includes authenticating the certificate revocation notification. In one embodiment, this step 204 may be performed as discussed above in FIG. 3 by the operation of the authenticator 104 utilizing the first verification value generator 134, the second verification value generator 136 and the comparator 138. Step 206 includes updating data representing at least one private or public key based on the certificate revocation notification. As discussed with regard to FIG. 1, the updater 106 may provide the update command 126 to the data representing at least one private or public key 107. As such, in one embodiment, this method is complete, step 208.

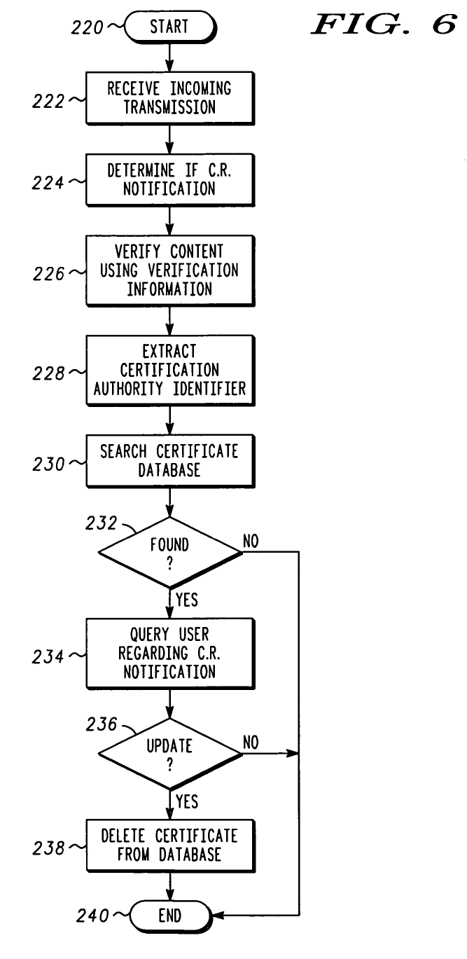

FIG. 6 illustrates the steps of another embodiment of a method for providing certificate based cryptography in a plurality of mobile devices, the method begins, step 220, by receiving an incoming transmission 222. In one embodiment, the incoming transmission is a wireless transmission 110 received by a receiver 102. Step 224 includes determining if the incoming transmission included a certificate revocation notification. In one embodiment, the content dispatcher 130 of FIG. 3 may perform this operation.

Upon a determination of step 224, step 226 includes verifying the content of the certificate revocation notification using verification information. In one embodiment, the verification information includes the information within the certificate revocation notification 112 utilized by the authenticator 104 to generate authentication of the certificate revocation notification. Step 228 includes extracting a certification authority identifier. In one embodiment, this may be performed by the CR parser 132 or may further be performed by the searcher 140 in response to receiving the certificate revocation notification 112 from the CR parser 132.

Step 230 includes searching a certificate database. The certificate database 144 includes one or more data representing a certificate of interest. A determination is made if the certificate of interest is found within the database, step 232. If a certificate is found, the step 234 includes querying a user regarding the certificate revocation notification.

Based on the user query, a response is determined whether to update the certificate database 144. If the user wishes to update the database, step 238 includes deleting the certificate from the database, wherein another embodiment the certificate may be disabled within the database and not specifically deleted. In the event that step 232 or step 236 are in the negative, the method proceeds to step 240 where in one embodiment, the method is complete.

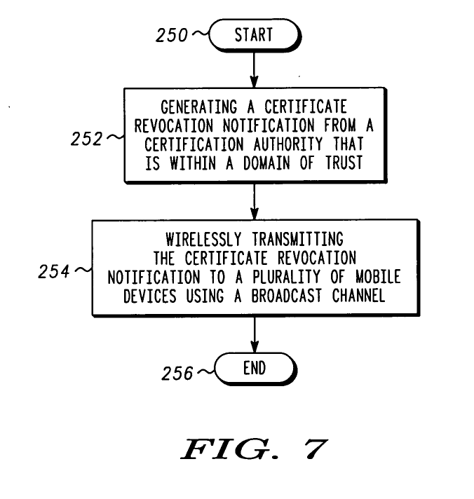

FIG. 7 illustrates method steps of the system of FIG. 4 providing certificate based cryptography. The message begins, step 250 by generating a certificate revocation notification from the certification authority that is within a domain of trust, step 252. As described above with regard to FIG. 4, the certificate revocation notification is generated by the operator 174 utilizing standard processing techniques to calculate the terms for the certificate revocation notification 112 of FIG. 2. The certificate revocation notification is generated by the operator 174 from the certificate revocation 172 received from the CA vendor 170. As discussed above, the CA vendor 170 is within the domain of trust.

Step 254 includes wirelessly transmitting the certificate revocation notification to a plurality of mobile devices using a broadcast channel. As further illustrated in FIG. 4, the wireless network 180 utilizes a broadcast channel to wirelessly transmit either a broadcast message, such as 176 or a messaging system message 184 to the mobile devices 100. As discussed above, a broadcast message 176 may include a channel identifier indicating a dedicated broadcast channel and the messaging system message 184 may include an assigned port ID. As such, the mobile devices 100 receive in a push technique certificate revocation notifications such that the mobile devices 100 may actively maintain a list of trusted certificates. As such, in one embodiment this method is complete, step 256.

It should be understood that there exists implementations of other variations and modifications of the invention and its various aspects, as may be readily apparent to those of ordinary skill in the art and that the invention is not limited by the specific embodiments described herein. For example, the messaging system utilized to transmit a SMS message may be any suitable messaging system such as but not limited to the extended messaging system (EMS) and the multi-modal messaging system (MMS). It is therefore contemplated and covered by the present invention, any and all modifications, variations or equivalents that fall within the spirit and scope of the basic underlying principles disclosed and claimed herein.

1. A mobile device for providing certificate based cryptography, the mobile device comprising:
a receiver operative to receive a wireless transmission of a certificate revocation notification over a broadcast channel;
an authenticator operative to receive the certificate revocation notification, the authenticator operative to authenticate signed comparison data included within the certificate revocation notification; and
an updater, coupled to the authenticator, the updater operative to update data representing at least one private or public key based on the certificate revocation notification.

2. The mobile device of claim 1 wherein the certificate revocation notification includes a certification authority identifier, revocation reason data, and data representing a certificate of interest.

3. The mobile device of claim 2 further comprising a searcher operative to receive the certification authority identifier from the authentication module, the searcher operative to retrieve a stored certificate corresponding to the certification authority identifier.

4. The mobile device of claim 3 wherein the authenticator further includes a first verification value generator operative to generate a first verification value based on the signed comparison data and the data representing a certificate of interest; a second verification value generator operative to generate a second verification value based on the certification authority identifier and the revocation reason data; and a comparator operative to compare to the first verification value and the second verification value.

5. The mobile device of claim 2 wherein the signed comparison data is a compressed representation of the combination of the certification authority identifier and the revocation reason data using a hash algorithm.

6. The mobile device of claim 2 wherein the data representing a certificate of interest is at least one of: a certificate and a universal resource locator.

7. The mobile device of claim 1 wherein the channel is at least one of: a dedicated broadcast channel and a channel assigned a predetermined port identifier in a messaging system.

8. The mobile device of claim 7 wherein the messaging system is at least one of a: short messaging system and an extended messaging system.

9. The mobile device of claim 1 further comprising:
a user interface coupled to the searcher, the user interface operative to receive user display information regarding the certificate revocation notification and the user interface coupled to the updater wherein the updater is operative to update the data representing at least one private or public key based on a user input received by the user interface module.

10. A method for providing certificate based cryptography in a mobile device, the method comprising:
receiving a certificate revocation notification from a wireless transmission over a broadcast channel;
authenticating the certificate revocation notification; and
updating data representing at least one private or public key based on the certificate revocation notification.

11. The method of claim 10 wherein the certificate revocation notification includes a certification authority identifier, revocation reason data, signed comparison data and data representing a certificate of interest.

12. The method of claim 11 further comprising generating a first verification value from the signed comparison data and the data representing a certificate of interest; generating a second verification value based on the certification authority identifier and the revocation reason data; and comparing the first verification value with the second verification value.

13. The method of claim 12 further comprising: accessing data representing at least one private or public key; and retrieving a certificate based on the certification authority identifier.

14. The method of claim 13 further comprising displaying friendly name data extracted from the certificate revocation notification and the revocation reason data; and querying an end user to remove the certificate from the data representing a certificate of interest.

15. The method of claim 11 wherein the data representing a certificate of interest is at least one of: a certificate and a universal resource locator.

16. The method of claim 10 wherein the broadcast channel over which the wireless transmission of the certificate revocation notification is received is at least one of: a dedicated broadcast channel and a messaging system channel.

17. The method of claim 18 wherein a messaging system using the messaging system channel is at least one of a: short messaging system and an extended messaging system.

18. A method for providing certificate based cryptography in a plurality of mobile devices, the system comprising:
generating a certificate revocation notification from a certification authority, wherein the certification authority is within a domain of trust; and
wirelessly transmitting the certificate revocation notification to the plurality of mobile device using a broadcast channel.

19. The method of claim 18 wherein the certificate revocation notification includes a certification authority identifier, revocation reason data, signed comparison data and data representing a certificate of interest.

20. The method of claim 18 wherein the broadcast channel is a messaging system broadcast channel and the messaging system is at least one of: a short messaging system and an extended messaging system.

21. The method of claim 18 wherein when the broadcast channel is a dedicated certificate revocation notification broadcast channel.

22. A method for providing certificate based cryptography in a mobile device, the method comprising:
receiving a certificate revocation notification from a wireless transmission over a broadcast channel, wherein the certificate revocation notification includes a certification authority identifier, revocation reason data, signed comparison data and data representing a certificate of interest;
authenticating the certificate revocation notification, wherein the authenticating includes:
generating a first verification value from the signed comparison data and the data representing a certificate of interest;
generating a second verification value based on the certification authority identifier and the revocation reason data; and
comparing the first verification value with the second verification value; and
updating data representing at least one private or public key based on the certificate revocation notification;

23. The method of claim 22 further comprising: accessing data representing at least one private or public key; retrieving a certificate based on the certification authority identifier; displaying friendly name data extracted from the certificate revocation notification and the revocation reason data; and querying an end user to remove the certificate from the data representing a certificate of interest.

24. The method of claim 22 wherein the broadcast channel over which the wireless transmission of the certificate revocation notification is received is at least one of: a dedicated broadcast channel and a channel assigned a predetermined port identifier in a messaging system.
